(19) United States
(12) Patent Application Publication
(10) Pub. No.: US 2009/0125539 A1
(43) Pub. Date: May 14, 2009

(54) METHOD AND SYSTEM FOR CONNECTING WORDS, PHRASES, OR SYMBOLS WITHIN THE CONTENT OF TRANSMITTED DATA TO URI OR IP ADDRESS

(76) Inventors: Junsheng Edward Sang, Shanghai (CN); Chengtao Mo, Shenzhen (CN)

Correspondence Address: KENYON & KENYON LLP, ONE BROADWAY, NEW YORK, NY, 10004, US

(21) Appl. No.: 11/721,798

(22) PCT Filed: Jun. 9, 2005
(86) PCT No.: PCT/CN2005/000816

§ 371 Date: Nov. 19, 2008

(30) Foreign Application Priority Data
Sep. 17, 2004 (CN) 2004 10066475.7

(51) Int. Cl. G06F 17/30

(52) U.S. Cl. 707/102; 707/103 R; 707/E17.005; 707/E17.045

(57) ABSTRACT

This invention relates to the field of wireless data communication technologies and network domain name parsing technologies, provides a method and a system for connecting words, phrases, or symbols of any languages or multimedia expressions, within the content of transmitted data, to URI or IP Addresses. The presented method of the invention defines Telecom Codes, Content Names, and connections, receives and analyzes the transmitted content, and transmits it to the corresponding URI or IP Addresses. The presented system of the invention combines both software and hardware functions, with the hardware portion comprising a Processor, a Memory, a Display Device, an Input Device, and a Communication Interface, and the software portion comprising an Operating System, a Client Data Management Module including Management Interface, a Database Software, a collection of URI or IP Addresses configured in the Database Software, a group of defined Content Names configured in the Database Software, the Connection relations and the Rules of assignment configured in the Database Software, analysis and directing functional modules, and communication interfaces. The presented method and system of the invention has solved the problems associated with URI or IP Addresses, which can be very difficult to memorize and cumbersome and inefficient to key in, and have developed new applications: WAP Site Linkage, Multiple Content Names Connecting to a Single URI or IP Address, Grouping and Search of WAP Pages.

### FIELD OF THE INVENTION

This invention relates to the data communication technologies and the associated system configurations of hardware and software components; in particular, it closely relates to the wireless data communication technologies and network domain name parsing technologies. This invention provides a method and a system for connecting words, phrases, or symbols of any languages or multimedia expressions, within the content of transmitted data, to URI for IP Address.

### BACKGROUND OF THE INVENTION

The end users or cell phone users can access the WAP (Wireless Application Protocol) site through proxy servers provided by Telecom Carriers. There are two methods for a user to access a particular WAP site: 1. The user inputs the URL or IP address of that particular WAP site on the terminal to get on the WAP site; 2. The user can get on the homepages provided by the Telecom Carriers, and is then redirected to the particular WAP site. The first method requires the end user to input the URL or IP addresses such as “http://.www., .com” on his or her cell phone, which may not be simple tasks, or sometimes particulars of WAP sites for input are difficult to remember for end users, resulting in poor user experiences. The second method requires the end user to sign on the homepage provided by Telecom Carriers to access the particular WAP site that the end user intends to visit. Under this way, the end user has to go through various menu layers to locate the link to the particular WAP site. The process is very inefficient. In addition, the second method does not work at all when the homepage provided by Telecom Carriers does not have a page link to the particular WAP site that the end user is looking for.

### DESCRIPTION OF THE INVENTION

The purpose of this invention is to provide a method for connecting words, phrases, or symbols of any languages or multimedia expressions, within the content of the transmitted data, to the content-name-to-address connection system of the URI or IP Address. This method and system reduces the difficulty of memorization and input cumbersomeness associated with URI or IP Address, and develops three new applications based on the method and system: WAP Site Linkage, Multiple Content Names Connecting to a Single URI or IP Address, Grouping and Search of WAP Sites/Pages.

This invention includes the following steps:

a). build up a category, and list the URI or IP Addresses into a corresponding directory, the URI or IP Address can represent any objects;

b). Define a unique format or form of any selected word(s), phrase(s), or symbol(s) from any languages, or of any multimedia expressions, or of any combination of the above, as a Content Name. Each of such unique Content Names can be located in any place within the transmitted data. All the defined Content Names are configured in a database;

c). assign a specific Content Name to a specific URI or IP Addresses, the connection relations and the assignment rules are characterized as the validness and effectiveness in the match of the content name and the URI or IP, but are not necessarily on an one-to-one basis, the connection relations and of the assignment rules are configured in the database;

d). design the logic structures and computing programs to manage the SMS Short Codes in the Database, Content Names, and assignment functions, to receive the transmitted content, to extract the Content Names from the contents, to search the particular URI or IP Address corresponding to the Content Names, and to notify the terminal to sign on the URL or IP corresponding to the content of the information;

e). Set up a system including both software and hardware portions, which can independently accomplish the functions of connecting words, phrases, or symbols of any languages or multimedia expressions, within the content of the transmitted data, to a URI or IP Address. The hardware portion of this system comprises a Processor, a Memory, a Display Device, an Input Device, and a Communication Interface, and the software portion of the system comprises an Operating System, a Client Data Management Module, a Database Software, a collection of categorized URI or IP addresses configured in the Database Software, a group of defined Content Names configured in the Database Software, the connection relation and the Assignment rule configured in the Database Software, Functional Modules, and Communication Interfaces;

f). Debug the system itself and the connection between the system and the telecommunication interface.

Description of the three application developments based on this invention is as follows:

### 1. The Linkage of WAP Sites

The linkage of WAP Sites can be provided by the presented method and system described in the invention. An end user only needs to remember and use an SMS Short Code, such as shared SMS service code 9682, and to key in a defined Content Name such as “Hospitals” in SMS, and then send the Content Name to the SMS Short Code. A linkage message of connecting to the corresponding WAP site will be received by the user. In the example above, a user writes an SMS “Hospitals” on his/her cell phone, and then sends the SMS to SMS Short Code 9682, the system built upon this invention sends back a list of all registered hospitals, the user's responding to any single selection on the list is further directed to the selected Hospital's WAP site. Such a direct linkage of WAP sites offers easy access of vast amount of information on many subjects, such as News, Financial Services (Banking and Stock Markets), Weather, Travel, Hotels, Restaurants, Insurance, Healthcare, Fashion, Entertainment, etc. The key advantage of the presented method and system based on the invention is to provide end users an easy and direct connection to the WAP sites of their interests.

### 2. Multiple Content Names Connecting to Single URI or IP Address

Multiple Content Names can be connected to the URI or IP Address of a particular WAP site, based on the invented method and system. A particular WAP site can be directly linked to the Content Names in Chinese, English, Japanese, Korean, or Nick Names, or any chosen names, as long as such a Content Name is unique and not yet assigned for connection to any URI or IP Address in the invented system. An end user keys in any one of the assigned Content Names and sends it to an SMS Short Code such as 9682, and then can directly sign on a corresponding WAP site to obtain the information of interests.

### 3. Grouping and Search of WAP Pages

A grouping and search system of WAP pages is built based on the presented method and system of the invention. After a content name is registered under the corresponding category, the user can send the defined content through the shared SMS service code 9682 to find the registered WAP pages and obtain the corresponding information; the user can also send the category name to the shared SMS service code to obtain all the registered WAP sites under this category.

### DESCRIPTION OF THE DRAWINGS

FIG. 1 shows the position of the invented system in a wireless communication network.

FIG. 2 is a block diagram of the preferred configuration of the hardware modules in the invented system.

FIG. 3 is a block diagram of the preferred configuration of the software functional modules in the invented system.

FIG. 4 is a flow diagram depicting a preferred process implemented by the invented system.

### DESCRIPTION OF THE PREFERRED EMBODIMENTS

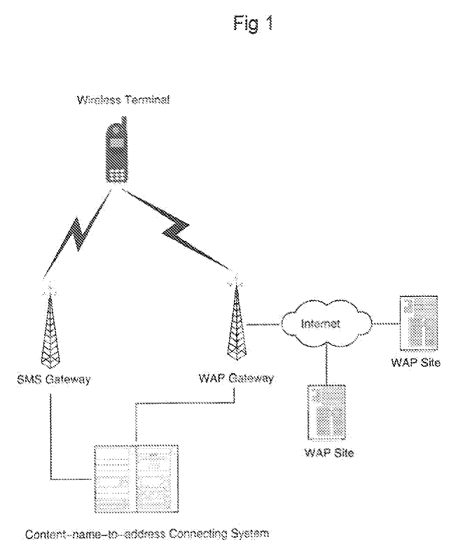

The presented invention relates to the wireless data communication technologies. FIG. 1 shows the position of fee invented system in the overall structure of a wireless communication network. The preferred architecture, comprising all hardware components and necessary software programs, can be divided into five portions: Wireless Terminals, SMS Gateway, WAP Gateway, WAP Servers, and the presented system (Content-name-to-address Connecting System). Wireless Terminals are cell phones (or mobile devices) used by the end users, which must be registered with wireless networks, such as those of China Mobile or China Unicom, and must support SMS and WAP technologies. SMS Gateway is a server (or servers) for sending/receiving/routing SMS set up by the Mobile Telecom Carriers, such as China Mobile or China Unicom. While its detailed system implementation is not restricted, it must provide a technical interface for the SMS Service Providers to connect to their systems. WAP Gateway is a proxy server (or servers) for enabling end users' view of WAP content set up by the Mobile Telecom Carriers (such as China Mobile or China Unicom). While its detailed system implementation is not restricted, it must provide a technical interlace for the WAP Service Providers to connect to their systems. WAP Sites represent these servers hosting WAP contents on Internet. The invented system of five portions forms two routes of communication to perform functions, one route connects Terminals to SMS Gateway to deliver SMS content to end users, and another route consists of Terminals, WAP gateway and the WAP sites to deliver WAP contents to the end users. The presented Content-name-to-address connecting system interconnects these two communication routes to create easy and rapid access of WAP contents for end users.

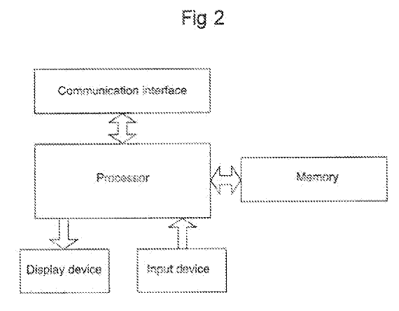

The invented system comprises a hardware portion and a software portion, and only the combination of both as a whole is capable of executing the functions of connecting words, phrases, or symbols of any languages or multimedia expressions, within the content of the transmitted data, to URI or IP Address. FIG. 2 is a block diagram of the preferred configuration of the hardware modules in the invented system. The hardware portion comprises a Processor, a Memory, a Display Device, an Input Device, and a Communication Interface, of which all components are of prior arts and can be purchased in the open market. The computers of prior arts configured as above may meet the hardware requirements of the invented system, although they may not be at the best configuration.

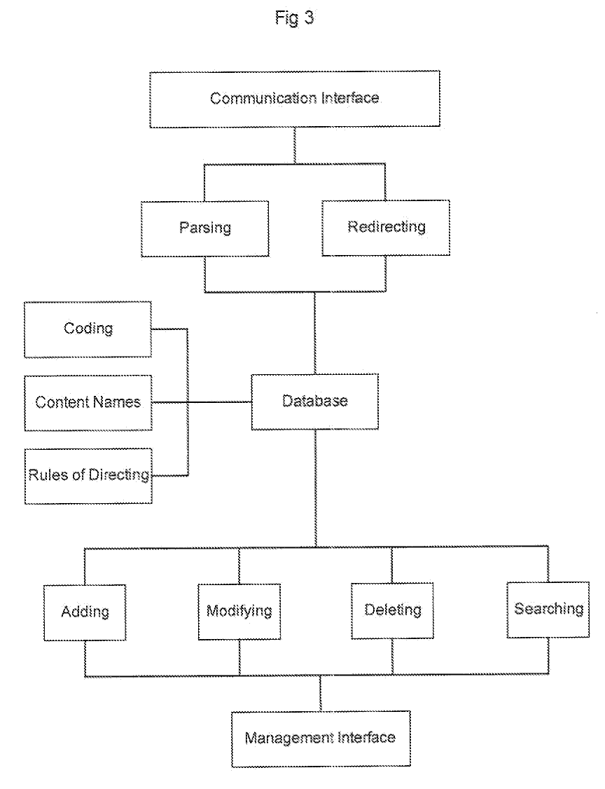

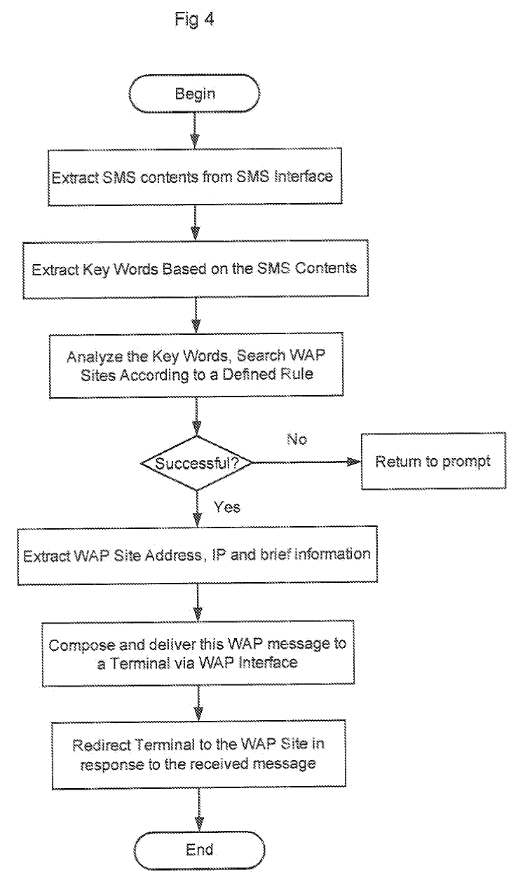

FIG. 3 is a block diagram of preferred software functional modules of the invented system. Such a software portion comprises an Operating System, Client Data Management Modules, a Database Software, a collection of WAP site addresses configured in the Database Software in groups, a group of defined Content Names configured in the Database Software, the connection relations and the Rules of assignment configured in the Database Software, a Key Word Analysis Module, a Search/Match Module, SMS interface Program, WAP Interface Program, a WAP Push Module, an Analysis and Recording Module, a Recording and Reporting Module, an Accounting Function Module, and a System Monitoring Module. The preferred software programs comprise the Operating System of prior arts, the Database Software of prior arts, and all other self-developed application software programs based on the method of this invention. Client Data Management Modules retrieve and maintain the registered data of the clients in the Database. The connection between the Content Names to the WAP site addresses must be executable, but is not necessarily on a one-to-one basis. The Key Word Analysis Module and the Search/Match Module are the core software modules of the invented system as it is responsible for analyzing the content of the user's input, extracting the Key Words, searching the data configured in the database and the rules of assigning connections, and thus searching the destination of the WAP Address, and finally activating WAP Push Module to send the WAP Address to Wireless Terminals, Analysis and Recording Module conducts analysis on the system to help diagnosing the system and to assist optimizing the system, and also records daily operation information and analytical results. Recording and Reporting Module helps in processing data to produce reports. Accounting Function Module analyzes the number of the customers and bookkeeping data to produce records. System Monitoring Module conducts surveillance on the system's functions and launches rescue operations when the system becomes malfunctioning.

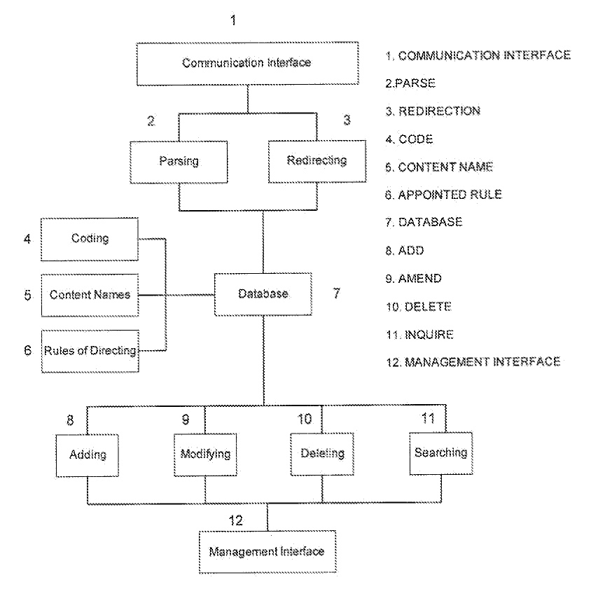

FIG. 4 is a flow diagram depicting a preferred process implemented by the invented system, which demonstrates a preferred embodiment of a working process and working principles of the invented method. At first, a client needs to register in the invented system, as an example with a corporation name “Shanghai Shuangai Information Technology Co. Ltd”. The corporation expects that it is easier for its customers to remember the corporation's brand name “Shanghai Shuangai” (in Chinese name). Therefore, using the brand name in Chinese as the Content Name, the corporation registers “Shanghai Shuangai” in order for it to connect to WAP site address “http://wap.7234.com”. A system administrator of the presented system is responsible for checking and confirming the accuracy of the registered data. When a cell phone user desires to get more information on “Shanghai Shuangai information Technology Co. Ltd”, but has no other means available, he/she can write its known brand name in Chinese as the Content Name “Shanghai Shuangai”, and then send it to an SMS Short Code such as “9682”. By this means, the cell phone user does not need to know and to key in the WAP site address (in English) of the corporation “Shanghai Shuangai Information Technology Co. Ltd”. After the SMS sent from a cell phone reaches the corresponding Mobile Telecom Carriers, it passes through its SMS Gateway and reaches the presented system of the invention. The presented system of the invention activates programs to analyze the existence and validity of Content Names within SMS content. When the system fails to analyze the SMS, it responds by sending back an error message to cell phone users to remind “your input may be wrong”. When the SMS formality is passed, the Key Word Analysis Module of the invented system checks and extracts the key words, as in the example above, “Shanghai Shuangai” as a Content Name. After detecting the registered Content Name successfully, the presented system of the invention searches the connected WAP site address based on the rules of connection. When the rule is a precise connection to the assigned WAP site address, the search/match result based on the registered data reveals the connected WAP site address “http://wap.7234.com”. If the corporation has never registered in the presented system of the invention, or the customer has input unrecognizable SMS content, the process of matching and connecting will fail and the presented system will respond by sending an error SMS message, such as “there is no any corresponding WAP Address”, to the origin cell phone user. After a matching WAP site address is found, the presented system of the invention composes WAP site address and a brief information into a WAP message formatted acceptable by terminals, then activates WAP Push Module to send this responding WAP message to WAP Gateway of the Mobile Telecom Carriers, and then it reaches the origin end user's cell phone. In this case, the user's cell phone displays the responding WAP message showing “Shanghai Shuangai, easy access of wireless Internet”. The origin cell phone user can just activate this responding WAP message to connect to the WAP site of the corporation to know more about the company. During the entire process, there is no need for the origin cell phone user to know or memorize the WAP site address of the corporation. As such, the presented method and system of the invention have solved the problems associated with WAP Address or WAP site address, which, can be very difficult to memorize and cumbersome and inefficient to key in, and have developed new applications based on the invention.

1. A method for connecting words, phrases, or symbols within the content of the transmitted data or multimedia expressions to URI or IP Address, comprising steps of:
a). building up a category, and list the URI or IP Addresses into a corresponding directory, the URI or IP Address can represent any objects;
b). defining a unique format or form of any selected word(s), phrase(s), or symbol(s) in any languages, or of any multimedia expressions, or of any combination of the above, as a Content Name, each of such unique Content Names can be located in any place within the transmitted data, all the defined Content Names are configured in a database;
c). assigning the specific Content Name(s) to the specific URI or IP Addresses, the connection relations and the assignment rules are characterized as valid and effective, but are not necessarily on an one-to-one basis, each of the connection relations and of the assignment rules is configured in the database;
d). designing a logic structure and computing programs to manage the SMS Short Codes in the Database, Content Names, and assignment functions, to receive the transmitted content, to extract the Content Names from the contents, to search the particular URI or IP Address corresponding to the Content Names, and to notify the terminal to sign on the URL or IP corresponding to the content of the information.

2. The method in claim 1, wherein the URI or IP Address is URI or IP Address of multimedia expression or stream media.

3. The method in claim 1, wherein the URI or IP Address is the URI or IP Address of a WAP site.

4. The method in claim 1, wherein the contents of transmitted telecom data are SMS contents in wireless communications or instant message (IM) contents in instant communications.

5. The method in claim 1, wherein the defined Content Names are any of the selected word(s), phrase(s), or symbol(s) in any languages, or of any combination of the above.

6. The method in claim 5, wherein the defined Content Names are any of the selected word(s), phrase(s), symbol(s) in Chinese, English, French, German, Russian, Spanish, Japanese, Korean, Thai, Vietnamese, Indian, Turkey, or Arabic, or of any combination of the above.

7. The method in claim 1, wherein assignments of the specific Content Names corresponding to URIs or IP Addresses are in three types: a specific Content Name connecting to a specific URI or IP Address, a specific Content Name connecting to two or more URIs or IP Addresses, two or more specific Content Names corresponding to a specific URI or IP Address.

8. A system for connecting words, phrases, or symbols within the content of transmitted data to URIs or IP Addresses, including both software and hardware portions, the combination of which can independently accomplish the functions of connecting words, phrases, or symbols of any languages or multimedia expressions, within the content of transmitted data, to URIs or IP Addresses, the hardware portion of this system comprises a Processor, a Memory, a Display Device, an Input Device, and a Communication Interface, and the software portion of the system comprises an Operating System, Client Data Management Modules includes a Management Interface, a Database Software, a collection of URIs or IP Addresses configured in the Database Software, a group of defined Content Names configured in the Database Software, the Connection relations and the Rules of assignment configured in the Database Software, Analysis and Redirecting Function Modules, and Communication Interfaces.

9. The system in claim 8, wherein the hardware portion is configured with computing hardware components and parts of prior arts and the software programs include the Operating System of prior arts and the Database Software of prior arts.

10. The system in claim 9, wherein the hardware portion is a computer of prior arts with the required hardware configuration.
